(19) United States
(12) Patent Application Publication
(10) Pub. No.: US 2026/0049216 A1
(43) Pub. Date: Feb. 19, 2026

(54) A METHOD FOR PRODUCING A CARBON MATERIAL FROM AGGLOMERATED LIGNIN

(71) Applicant: Stora Enso OYJ, Helsinki (FI)

(72) Inventors: Abhishek Shetty, Nacka (SE); Vilhelm Olsson, Täby (SE); Mario Wachtler, Strängnäs (SE)

(73) Assignee: Stora Enso OYJ, Helsinki (FI)

(21) Appl. No.: 19/103,929

(22) PCT Filed: Aug. 17, 2023
(86) PCT No.: PCT/IB2023/058245

§ 371 Date: Feb. 14, 2025

(30) Foreign Application Priority Data
Aug. 17, 2022 (SE) 2230268-1

(51) Int. Cl. C08L 97/00; C01B 32/05; C08J 3/12

(52) U.S. Cl. CPC C08L 97/005; C01B 32/05; C08J 3/126; C08J 2397/00; C08L 2207/53

(57) ABSTRACT

The present invention relates to a method for producing an agglomerated lignin-thermoset resin material. The method comprises the steps of providing lignin, providing at least one thermoset resin, forming an agglomerated lignin-thermoset resin material, and curing the agglomerated lignin-thermoset resin material. The present invention also relates to a method for producing a carbon material, comprising heat treatment of the agglomerated lignin-thermoset resin material so as to obtain said carbon material. The obtained carbon material is suitable for use as active material in a negative electrode of a secondary battery.

### FIELD OF THE INVENTION

The present invention relates to a method for producing an agglomerated lignin-thermoset resin material and an agglomerated lignin-thermoset resin material. The present invention also relates to a method for producing a carbon material from said agglomerated lignin-thermoset resin material, and to a carbon material obtainable by the method. The present invention further relates to a negative electrode for a secondary battery comprising said carbon material as active material. The present invention further relates to use of said carbon material as active material in a negative electrode for a secondary battery.

### BACKGROUND

Secondary batteries, such as lithium-ion batteries, are electrical batteries which can be charged and discharged many times, i.e. they are rechargeable batteries. In lithium-ion batteries, lithium ions flow from the negative electrode through the electrolyte to the positive electrode during discharge, and back when charging. Typically, a lithium compound, in particular a lithium metal oxide such as lithium nickel manganese cobalt oxide (NMC) or alternatively a lithium iron phosphate (LFP), is utilized as material of the positive electrode and a carbon enriched material is utilized as material of the negative electrode.

Graphite (natural or synthetic graphite) is today utilized as material of the negative electrode in most lithium-ion batteries. An alternative to graphite is amorphous carbon materials, such as hard carbons (non-graphitizable amorphous carbons) and soft carbons (graphitizable amorphous carbons), which lack long-range graphitic order. Amorphous carbons can be used as sole active electrode materials or in mixtures with graphite (and/or other active materials).

Amorphous carbons can be derived from lignin. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. hard carbons.

Lignin has a complex chemical structure which depends largely on its origin, such as the type of plant or tree from which the lignin is obtained. The properties of lignin, such as its glass transition temperature vary significantly depending on the chemical structure, the composition of the lignin as well as any impurities present. In particular, lignin obtained from hardwood, such as Eucalyptus, has a relatively lower glass transition temperature than lignin obtained from softwood.

Today, the most commercially relevant source of lignin is kraft lignin, obtained from hardwood or softwood through the kraft process. The lignin can be separated from alkaline black liquor using for example membrane-or ultrafiltration. One common separation process is described in WO2006031175 A1. In this process lignin is precipitated from alkaline black liquor by reducing the pH level of the black liquor, usually by adding carbon dioxide, and then filtered off. The lignin filter cake is in the next step re-slurried under acidic conditions, commonly using sulfuric acid, and washed. The precipitated washed lignin can be used as it is or further dried.

One problem with using lignin as a precursor for a carbon enriched material is that direct use of lignin, in the form of a fine powder, is not suitable since it exhibits undesired thermoplastic behavior, as well as a strong tendency for dust formation. During thermal conversion of lignin powder into carbon enriched materials, lignin undergoes plastic deformation/melting, aggressive swelling and foaming. This severely limits the processability of lignin in an industrially relevant scale, in terms of equipment dimensioning and process throughput as well as need of intermediate processing. In addition, dust formation increases the risk for dust explosions during processing.

The problems described above regarding undesired thermoplastic behaviour are particularly pronounced when processing lignin having a low glass transition temperature, such as lignin obtained from hardwood. For lignin having a low glass transition temperature, the problems related to melting, softening and decomposition will begin at a relatively lower temperature.

WO2021250604 A1 describes a method for forming agglomerated lignin from lignin powder. The agglomerated lignin is further stabilized by a thermal oxidation prior to heat treatment and conversion to a carbon material. Problems with deformation/melting and dust formation are further reduced by the use of agglomerated lignin that has subsequently been thermally stabilized. However, when lignin having a low melting point is used, melting and fusing may occur prior to reaching the temperature required for thermal stabilization.

Thus, there is still room for improvements of methods for producing an agglomerated lignin material as well as for methods for producing a carbon enriched material from lignin, regardless of the source of the lignin. The method should avoid that lignin undergoes plastic deformation/melting, aggressive swelling and foaming during any heating steps, as well as when converting the lignin to a carbon enriched material. The method should also avoid dust formation during processing of lignin. In addition, it should be possible to use the method in large-scale manufacturing.

### SUMMARY OF THE INVENTION

It is an object of the present invention to provide an improved method for producing a carbon enriched material, which method allows use of a renewable carbon source, and which method eliminates or alleviates at least some of the disadvantages of the prior art methods.

It is a further object of the present invention to provide a method that obtains an improved carbon enriched material starting from lignin, which carbon enriched material is suitable for use as active material in a negative electrode of a secondary battery, such as a lithium-ion battery.

It is a further object of the present invention to provide a method that obtains an agglomerated lignin that can be subjected to subsequent heat treatments with no melting/fusing or foaming occurring.

It is a further object of the present invention to provide a method for producing a carbon enriched material from lignin, which method allows heat treatment of lignin, regardless of the origin of the lignin, with retained shape.

It is a further object of the present invention to provide a method for avoiding dust formation during processing of lignin in powder form.

It is a further object of the present invention to provide a method for producing a carbon enriched material from lignin, which method is scalable and thus suitable for large-scale manufacturing.

The above-mentioned object, as well as other objects as will be realized by the skilled person in light of the present disclosure, are achieved by the various aspects of the present disclosure.

According to a first aspect, the present invention relates to a method for producing an agglomerated lignin-thermoset resin material, wherein the method comprises the steps of:
providing lignin;
providing at least one thermoset resin;
forming an agglomerated lignin-thermoset resin material having a particle size distribution such that at least 80 wt % of the agglomerates have a diameter within the range of from 0.2 mm to 5.0 mm, wherein the forming involves contacting the lignin with the at least one thermoset resin; and
curing the agglomerated lignin-thermoset resin material.

It has surprisingly been found that by forming an agglomerated lignin-thermoset resin material, a lignin material that after curing can be heat treated with retained shape, avoiding melting/swelling and deformation, is obtained. The dust formation during processing of lignin is also reduced by the inventive method. Surprisingly, the inventive method also facilitated thermal processing of lignin having a low glass transition temperature, such as lignin obtained from hardwood.

According to a second aspect, the present invention relates to an agglomerated lignin-thermoset resin material having a particle size distribution such that at least 80 wt % of the agglomerates have a diameter within the range of from 0.2 mm to 5.0 mm. The agglomerated lignin-thermoset resin material according to the second aspect may be obtained by the method according to the first aspect.

According to a third aspect, the present invention relates to a method for producing a carbon material, the method comprising the steps of:
providing an agglomerated lignin-thermoset resin material obtainable by the method according to the first aspect, or an agglomerated lignin-thermoset resin material according to the second aspect; and
subjecting the agglomerated lignin-thermoset resin material to heat treatment at one or more temperatures in the range of from 300° C. to 3000° C., wherein the heat treatment is carried out for a total time in the range of from 30 minutes to 10 hours, so as to obtain a carbon material.

It has surprisingly been found that by providing lignin in the form of an agglomerated lignin-thermoset resin material, the lignin material can be heat treated with retained shape, avoiding melting/swelling and deformation. The resulting carbon material is suitable for use in for example energy storage applications, such as active material in a negative electrode of a secondary battery.

According to a fourth aspect, the present invention relates to a carbon material obtainable by the method according to the third aspect.

According to a fifth aspect, the present invention relates to a negative electrode of secondary battery comprising the carbon material obtainable by the method according to the third aspect as active material.

According to a sixth aspect, the present invention relates to use of the carbon material obtainable by the method according to the third aspect as active material in a negative electrode of a secondary battery.

### DETAILED DESCRIPTION

One step of the method according to the first aspect involves providing lignin. It is intended throughout the present disclosure that the term “lignin” refers to any kind of lignin which may be used as the carbon source for making a carbon enriched material. Examples of said lignin are, but are not limited to, lignin obtained from vegetable raw material such as wood, e.g. softwood lignin, hardwood lignin, and lignin from annular plants. Also, the lignin can be chemically modified.

Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, based on the dry weight of the lignin material. Thus, the lignin material used according to the process of the present invention preferably contains less than 10%, preferably less than 5%, more preferably less than 2% impurities, such as cellulose, carbohydrates and inorganic compounds, based on the dry weight of the lignin material.

The lignin may be obtained through different extraction methods such as an organosolv process or a kraft process. Preferably, the lignin used in the method of the present invention is kraft lignin, i.e. lignin obtained through the kraft process. The kraft lignin may be obtained from hardwood or softwood.

Kraft lignin is readily available as a by-product from pulp production by the kraft process. Utilizing kraft lignin that would otherwise typically be discarded is beneficial from a sustainability point of view. Thus, by utilizing kraft lignin, a more sustainable method is enabled. Kraft lignin can be extracted on an industrial scale by well-known and established processes that result in lignin with consistent quality. Kraft lignin is therefore suitable to use in large-scale processing where the repeatability of the process is of high importance. The extracted kraft lignin can readily be chemically modified or cross-linked which facilitates further processing.

The lignin may be obtained by the process disclosed in WO2006031175 A1 commonly referred to as the LignoBoost process. Typically, this process involves the steps of precipitation of lignin from alkaline black liquor by acidification; separation of the precipitated lignin; and re-slurrying the lignin under acidic conditions at least once. The obtained lignin may be dried and pulverized and thus provided as solid particles.

The method according to the first aspect also involves providing at least one thermoset resin. The term “thermoset resin” as used herein, refers to a resin that is irreversibly hardened by curing. The term “thermoset resin” is not intended to cover precursors of thermoset resins, but only the resin obtained by reaction of one or several precursors. The type of thermoset resin is not particularly limited, and any suitable thermoset resin can be used in the method according to the present invention. In some embodiments, the at least one thermoset resin is selected from the group of furan resins, such as polyfurfuryl alcohol, epoxy-based resins, phenolic resins, such as bakelite, vinyl esters, melamine resins, and polyimides. Preferably, the thermoset resin is a furan resin, such as polyfurfuryl alcohol.

The at least one thermoset resin may be provided in the form of a liquid, or in solid form, such as in the form of a powder. The thermoset resin may be diluted using any suitable solvent. The thermoset resin may also comprise at least one additive. The at least one additive may for example influence the properties of the thermoset resin, or it may have an impact on the agglomerated lignin-thermoset resin material.

In some embodiments, one thermoset resin is provided. In some embodiments, more than one thermoset resin is provided, such as two different types of thermoset resins, or three different types of thermoset resins. The different types of thermoset resins may also be in different form, such as at least one being in the form of a liquid and at least one being in solid form.

The method according to the first aspect also involves forming an agglomerated lignin-thermoset resin material having a particle size distribution such that at least 80 wt % of the agglomerates have a diameter within the range of from 0.2 mm to 5.0 mm. The step of forming involves contacting the lignin with the at least one thermoset resin. The term “lignin-thermoset resin material” as used herein, refers to a material comprising both lignin and at least one thermoset resin. The lignin-thermoset resin material may optionally comprise at least one additive. The lignin-thermoset resin material of the present invention is a composite material comprising lignin and at least one thermoset resin. Lignin is contacted with a thermoset resin, and not with precursors of a thermoset resin. Thus, the lignin-thermoset resin material of the present invention is not a lignin-based thermoset resin. Such a lignin-based thermoset resin would be obtained for example if lignin were reacted with precursors of a thermoset resin. In the present invention, lignin is not modified by being contacted with the thermoset resin and there are no changes to the main polymeric structure of lignin.

The term “forming” as used herein, refers to a process of forming an agglomerated lignin-thermoset resin material by contacting lignin and at least one thermoset resin so that an agglomerated lignin-thermoset resin material is obtained. The term “contacting” as used herein, refers to the process of putting lignin and at least one thermoset resin in close proximity to each other. In some embodiments, there are no, or essentially no, chemical reactions occurring between lignin and the at least one thermoset resin in the contacting step. In other embodiments, some chemical reactions may occur between the thermoset resin and reactive sites of lignin in the contacting step.

In preferred embodiments of the present invention the agglomerated lignin-thermoset resin material comprises from 80 to 99 wt %, or from 90 to 99 wt %, or from 95 to 99 wt % lignin, based on the total weight of the agglomerated lignin-thermoset resin material. In such embodiments, the amount of lignin is always considerably higher than the amount of thermoset resin in the contacting step. Thus, if some chemical reactions occur between the thermoset resin and lignin, only a minor portion of the lignin within the agglomerated lignin-thermoset resin material will have reacted whereas a major portion of the lignin will remain unaltered by the contacting step.

The term “agglomerated” as used herein in terms such as “agglomerated lignin” and “agglomerated lignin-thermoset resin material” refers to macroscopic particles in turn comprising clustered smaller particles of lignin, or of lignin and thermoset resin.

Depending on the provided lignin, the forming step may or may not involve an agglomeration step. The forming step may involve coating agglomerated lignin with at least one thermoset resin, or it may involve mixing lignin powder and at least one thermoset resin powder and subsequently form agglomerates from the mixture. In some embodiments, the total amount of thermoset resin in the agglomerated lignin-thermoset resin material is in the range of from 1 wt % to 70 wt %, such as from 1 wt % to 50 wt %, or from 1 wt % to 20 wt %, or from 1 wt % to 10 wt %, based on the total dry weight of the agglomerated lignin-thermoset resin material. By “total amount of thermoset resin” is meant the total amount of all thermoset resins present in the lignin-thermoset resin material.

In a preferred embodiment, the total amount of thermoset resin in the agglomerated lignin-thermoset resin material is in the range of from 1 wt % to 20 wt %, or from 1 wt % to 10 wt %, or from 1 wt % to 5 wt %, based on the total weight of the agglomerated lignin-thermoset resin material. It is advantageous to form an agglomerated lignin-thermoset resin material comprising low amounts of thermoset resin since the material in that case comprises mainly material from a renewable resource, enabling a more sustainable method. The cost of lignin is also typically lower than the cost of thermoset resin. Low amounts of thermoset resin, such as from 1 wt % to 5 wt %, based on the total weight of the agglomerated lignin-thermoset resin material, will improve the thermal properties of the agglomerated material sufficiently so as to avoid melting of lignin during heat treatment.

In some embodiments, the thermoset resin(s) may be derived from renewable sources. In such embodiments, the lignin-thermoset resin material may be entirely renewable.

The agglomerated lignin-thermoset resin material comprises from 30 to 99 wt %, or from 50 to 99 wt %, or from 80 to 99 wt %, or from 90 to 99 wt % lignin, based on the total weight of the agglomerated lignin-thermoset resin material. Preferably, the agglomerated lignin-thermoset resin material comprises from 80 to 99 wt %, or from 90 to 99 wt %, or from 95 to 99 wt % lignin, based on the total weight of the agglomerated lignin-thermoset resin material.

The agglomerated lignin-thermoset resin material may comprise only lignin and thermoset resin, or may comprise lignin, thermoset resin and at least one additive.

The amount of the at least one additive is typically small, such as below 5 wt %, or below 2 wt %, as based on the total weight of the agglomerated lignin-thermoset resin material.

The method according to the first aspect also involves curing the agglomerated lignin-thermoset resin material. Curing may be carried out at room temperature and/or at an elevated temperature. By increasing the temperature, the curing becomes faster. The temperature used during curing also depends on the type of thermoset resin.

In some embodiments, curing is carried out at one or more temperatures in the range of from 20° C. to 250° C., and wherein the curing is carried out for a total time of at least 30 minutes, i.e. the residence time of the agglomerated lignin-thermoset resin material inside the equipment used for the curing is at least 30 minutes. The total time for curing is preferably less than 24 hours. During curing, irreversible hardening of the at least one thermoset resin occurs. After curing, an agglomerated lignin-thermoset resin material that does not change its shape during any subsequent heat treatment is obtained. Also, addition of the thermoset resin material to the agglomerated lignin further reduces the melting/swelling behaviour of lignin during heating.

In some embodiments curing is carried out at one or more temperatures in the range of from 20° C. to 250° C., such as from 20° C. to 200° C., or 20° C. to 150° C., or 50° C. to 150° C., for a total time of at least 30 minutes. Preferably, curing is carried out at one or more temperatures in the range of from 20° C. to 150° C., or 50° C. to 150° C. for a total time of at least 30 minutes. In such embodiments, lignin exhibits no, or only minor, melting/swelling behaviour.

In embodiments where agglomerated lignin is coated with the at least one thermoset resin, it is believed by the present inventors that after curing the hardened thermoset resin will retain the lignin within the agglomerated lignin-thermoset resin material so that melting/swelling of lignin is prevented during any subsequent heat treatment at temperatures where lignin would normally exhibit melting/swelling behaviour.

In embodiments where lignin is mixed with the at least one thermoset resin prior to forming an agglomerated material, it is believed that a matrix of thermoset resin may be formed after curing, with lignin being contained within the matrix so that melting/swelling of lignin is prevented during any subsequent heat treatment at temperatures where lignin would normally exhibit melting/swelling behaviour.

In some embodiments, lignin may react with the thermoset resin during curing. In other embodiments, the only reactions that occur during curing is within the thermoset resin. In some embodiments there will be reactions between lignin polymer chains during curing. Thus, during curing there will be cross-linking reactions occurring within the thermoset resin and there may also be cross-linking reactions between the thermoset resin and lignin, and/or between different lignin polymer chains. Cross-linking reactions between lignin and thermoset resin as well as between different lignin polymer chains will reduce the melting/swelling behaviour of lignin during any subsequent heating steps at temperatures where lignin would normally exhibit melting/swelling behaviour. Cross-linking within the thermoset resin may create physical restrains that prevents melting/swelling of lignin.

Which reactions, apart from cross-linking of the thermoset resin, that occur during curing depends on for example the temperature and the type of thermoset resin used.

In some embodiments, curing is carried out using the same temperature throughout the entire curing step. In some embodiments, curing is carried out at room temperature for a total time of at least 30 minutes.

In some embodiments, curing is carried out at varying temperatures, such as using a stepwise increase of the temperature or using a temperature gradient. In some embodiments, the curing is carried out in several steps at different temperatures. The temperature may be increased from one step to the subsequent step by a temperature ramp or gradient. For example, the curing may be carried out by heating the agglomerated lignin-thermoset resin material to a first temperature in the range of from 20° C. to 250° C., such as from 20° C. to 200° C., or 20° C. to 150° C., or 50° C. to 150° C., followed by heating to a second temperature in the range of from 20° C. to 250° C., such as from 20° C. to 200° C., or 20° C. to 150° C., or 50° C. to 150° C., and so on, and holding at each selected temperature for a certain amount of time, such as in the range of from 10 minutes to 3 hours. By carrying out the curing in several steps at different temperatures, an improved crosslinking of the cured agglomerated lignin-thermoset resin material is achieved. The properties of the carbon material obtained by heat treatment of the agglomerated lignin-thermoset resin material is improved in terms of micro porosity by improving the crosslinking during curing of the agglomerated lignin-thermoset resin material. In addition, the risk of cracking of the agglomerated lignin-thermoset resin material during curing is decreased as the curing process can be carried out in a more controlled fashion.

In some embodiments, an acidic catalyst is added to the at least one thermoset resin material, and the curing of the agglomerated lignin-thermoset resin material is catalysed by the acidic catalyst. In one embodiment, the acidic catalyst is selected from sulfuric acid, maleic anhydride or p-toluene sulfonic acid. Curing using a catalyst can be carried out at room temperature and/or at an elevated temperature. The curing is faster at an elevated temperature.

Curing may be achieved using both a catalyst and an elevated temperature, or by only a catalyst, or by only an elevated temperature.

After forming and curing, an agglomerated lignin-thermoset resin material having a particle size distribution such that at least 80 wt % of the agglomerates have a diameter within the range of from 0.2 mm to 5.0 mm is obtained. Preferably, the particle size distribution is such that at least 90 wt-%, more preferably at least 95 wt-%, of the particles have a diameter in the range of from 0.2 mm to 5.0 mm. More preferably, at least 90 wt-%, more preferably at least 95 wt-%, of the particles have a diameter in the range of from 0.5 mm to 2 mm.

The agglomerated lignin-thermoset resin material preferably has a bulk density in the range of from 0.5 g/cm³ to 0.7 g/cm³, more preferably from 0.5 g/cm³ to 0.6 g/cm³.

In one embodiment of the present invention, the lignin in the method according to the first aspect is provided in the form of agglomerated lignin having a particle size distribution such that at least 80 wt % of the agglomerates have a diameter within the range of from 0.2 mm to 5.0 mm. The agglomerated lignin is preferably obtained by a method comprising the steps of:
a) providing lignin in the form of a powder, wherein the particle size distribution of the lignin in the form of a powder is such that at least 80 wt % of the particles have a diameter less than 0.2 mm and a moisture content of less than 45 wt %;
b) compacting the lignin powder of step a);
c) crushing the compacted lignin obtained in step b) so as to obtain agglomerated lignin; and
d) optionally sieving the agglomerated lignin obtained in step c) to remove particles having a particle diameter below 100 μm, thereby obtaining the agglomerated lignin having a particle size distribution such that at least 80 wt-% of the agglomerates have a diameter within the range of from 0.2 mm to 5.0 mm.

Preferably, the lignin in powder form is dried before compaction. The drying of the lignin is carried out by methods and equipment known in the art. The lignin in powder form used in step a) has a moisture content of less than 45 wt %. Preferably, the moisture content of the lignin before compaction according to the present invention is less than 25 wt %, preferably less than 10 wt %, more preferably less than 8 wt %. In one embodiment, the moisture content of the lignin before compaction according to the present invention is at least 1 wt %, such as at least 5 wt %. The temperature during the drying is preferably in the range of from 80° C. to 160° C., more preferably in the range of from 100° C. to 120° C.

The lignin powder obtained after drying has a wide particle size distribution ranging from 1 μm to 2 mm which is significantly skewed towards the micrometer range, meaning that a significant proportion of the particles has a diameter in the range of from 1 to 200 micrometers.

The compaction of the lignin is preferably carried out by roll compaction. The roll compaction of lignin can be achieved by a roller compactor to agglomerate the lignin particles. In the compaction step, an intermediate product is generated. Here, the fine lignin powder is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction are known in the art.

After compaction, crushing is preferably carried out. In the crushing step, the intermediate product from the compaction step is subjected to crushing or grinding, such as by means of a rotary granulator, cage mill, beater mill, hammer mill or crusher mill and/or combinations thereof. During this step, a further intermediate product is generated.

After crushing, the crushed material is preferably subjected to a sieving step, to remove fine material. In addition, large material, such as agglomerates having a diameter larger than 5.0 mm, may be removed and/or recirculated back to the crushing step. In the sieving step, the intermediate product from the crushing step is screened by means of physical fractionation such as sieving, also referred to as screening, to obtain a product which is agglomerated lignin with a defined particle size distribution set by the porosity of the sieves or screens in this step. The sieve or screen is selected such that most particles having a diameter below 100 (or 500) μm pass through the screen and are rejected and preferably returned to the compaction step, whereas most particles having a diameter above 100 (or 500) μm are retained and subjected to the subsequent heating step of the process according to the present invention. The sieving may be carried out in more than one step, i.e. the sieving can be carried out such that the crushed material from the crushing step passes sequentially through more than one screen or sieve.

In one embodiment of the roll compaction, the rolls configuration is such that the first roll has an annual rim in such configuration so that the powder in the nip region is sealed in the axial direction along the roller surface.

In one embodiment, the roll configuration is such that the nip region is sealed in the axial direction along the roller surface with a static plate. By ensuring that the nip region is sealed, loss of powder at the axial ends of the rollers is minimized as compared to entirely cylindrical nip rollers.

Due to the compaction of the lignin powder during preparation of agglomerated lignin, the bulk density of lignin will increase as pressure is applied to the lignin powder. This means that the agglomerated lignin will have a higher bulk density than the lignin powder. More compact lignin particles may be beneficial during subsequent processing to carbon enriched materials, as compact lignin particles have been found to retain its shape with no melting or swelling. The agglomerated lignin particles will also have a relatively higher hardness after compaction. Hard particles are advantageous during subsequent processing as they can resist physical impact during processing. Further, when using hard, compacted particles processing problems that might arise due to the presence of lignin dust on the surface of the particles are avoided. This is of particular importance in a large-scale process since dust can form explosive mixtures with air and also cause blockings inside processing equipment.

The agglomerated lignin preferably has a bulk density in the range of from 0.5 g/cm³ to 0.7 g/cm³, more preferably from 0.5 g/cm³ to 0.6 g/cm³. The lignin powder, prior to agglomeration, preferably has a bulk density in the range of from 0.3 g/cm³ to 0.4 g/cm³.

The agglomerated lignin has a particle size distribution such that at least 80 wt-% of the particles have a diameter in the range of from 0.2 mm to 5.0 mm. Preferably, the particle size distribution is such that at least 90 wt-%, more preferably at least 95 wt-%, of the particles have a diameter in the range of from 0.2 mm to 5.0 mm. More preferably, at least 90 wt-%, more preferably at least 95 wt-%, of the particles have a diameter in the range of from 0.5 mm to 2 mm.

In some embodiments, the lignin in the form of a powder is mixed with at least one additive prior to compaction. The mixing is performed by methods and equipment as known in the art. One example of a suitable method is a vertical mixer, such as paddle, screw or ribbon-screw mixer in a batch or continuous mode. The mixing process may be carried out in a low-, medium- or high-shear impact mode. Any suitable additives, such as binders or lubricants, may be added to facilitate the subsequent compaction process and to improve the density and mechanical properties of the obtained agglomerated lignin. In addition, additives having an influence on the properties of the final material may be added, such as functionality-enhancing additives. The total amount of additive(s) is preferably less than 5 wt %, such as less than 2 wt %, as based on the total dry weight of the mixture of lignin powder and additive(s). The compaction, crushing and optional sieving steps when producing agglomerated lignin from lignin powder mixed with additive are carried out as described above in relation to only using lignin powder with no additives.

In embodiments where lignin is provided in the form of agglomerated lignin, the at least one thermoset resin is preferably provided in the form of a liquid, and the step of forming an agglomerated lignin-thermoset resin material involves coating the agglomerated lignin with the at least one thermoset resin so as to obtain the agglomerated lignin-thermoset resin material. Any suitable methods for coating as known by a person skilled in the art can be used, for example spray coating or dip coating. By coating the agglomerated lignin with the thermoset resin, an outer layer of thermoset resin is obtained on the agglomerated lignin-thermoset resin material. After curing, this provides the agglomerated lignin-thermoset resin material with a hard, protective layer which reduces the formation of dust, as well as any tendencies for the agglomerated lignin-thermoset resin material to stick together due to melting/softening of the surface during the subsequent heat treatment. The bulk density of the agglomerated lignin is not affected to a significant extent by the coating with thermoset resin.

In embodiments where the at least one thermoset resin is in liquid form, the at least one thermoset resin may be diluted with a solvent. Dilution of the thermoset resin is preferably carried out if the thermoset resin has a high viscosity, in order to facilitate the subsequent coating step. Any suitable solvent for the at least one thermoset resin may be used, such as water, tetrahydrofuran or dichloromethane.

The agglomerated lignin-thermoset resin material may be dried after coating. Drying may be performed either at room temperature or at an elevated temperature. Drying may be performed using any suitable means as known by a person skilled in the art. Drying may be performed under ambient pressure, reduced pressure, or vacuum. In some embodiments, drying is performed at room temperature for at least 10 hours. In some embodiments, drying is performed at one or more temperatures below 60° C., such as in the range of from 30° C. to 60° C., for a time period in the range of from 5 minutes to 10 hours. After drying, the dry content of the agglomerated lignin-thermoset resin material is at least 50 wt %, such as at least 70 wt %, or at least 80 wt %. The drying step is of particular importance in embodiments where the thermoset resin has been diluted with a solvent, in order to remove the solvent.

If the agglomerated lignin-thermoset resin material has not been dried prior to curing at an elevated temperature, drying will occur simultaneously with curing.

In one embodiment of the present invention, the lignin provided in the method according to the first aspect is in the form of a powder, wherein the particle size distribution of the lignin in the form of a powder is such that at least 80 wt % of the particles have a diameter less than 0.2 mm and a moisture content of less than 45 wt %. Preferably, the lignin in powder form is dried before further processing into agglomerated lignin. The drying of the lignin powder is carried out by methods and equipment known in the art. The lignin in powder form has a moisture content of less than 45 wt %. Preferably, the moisture content of the lignin powder is less than 25 wt %, preferably less than 10 wt %, more preferably less than 8 wt %. In one embodiment, the moisture content of the lignin powder is at least 1 wt %, such as at least 5 wt %. The temperature during the drying is preferably in the range of from 80° C. to 160° C., more preferably in the range of from 100° C. to 120° C.

The lignin powder obtained after drying has a wide particle size distribution ranging from 1 μm to 2 mm which is significantly skewed towards the micrometer range, meaning that a significant proportion of the particles has a diameter in the range of from 1 to 200 micrometers.

In embodiments where lignin is provided in the form of a powder in the method according to the first aspect, the at least one thermoset resin is preferably provided in the form of a powder. The thermoset resin powder may be obtained by freezing and subsequent crushing of a thermoset resin in liquid form. The moisture content of the thermoset resin in the form of a powder is preferably less than 1 wt %.

In embodiments where lignin and the at least one thermoset resin are both provided in the form of a powder, the step of forming an agglomerated lignin-thermoset resin material preferably comprises the following steps:
i) mixing the lignin powder, the at least one thermoset resin powder and optionally at least one additive so as to obtain a lignin-thermoset resin mixture;
ii) compacting the lignin-thermoset resin mixture obtained in step i) so as to obtain a lignin-thermoset resin material;
iii) crushing the lignin-thermoset resin material obtained in step ii) so as to obtain an agglomerated lignin-thermoset resin material; and
iv) optionally sieving the agglomerated lignin-thermoset resin material obtained in step iii) so as to remove particles having a particle diameter below 100 μm, thereby obtaining the agglomerated lignin-thermoset resin material having a particle size distribution such that at least 80 wt % of the agglomerates have a diameter within the range of from 0.2 mm to 5.0 mm.

The mixing of the lignin powder, the thermoset resin powder and optionally at least one additive is performed by methods and equipment as known in the art. One example of a suitable method is a vertical mixer, such as paddle, screw or ribbon-screw mixer in a batch or continuous mode. The mixing process may be carried out in a low-, medium-or high-shear impact mode. By ensuring that mixing is sufficient, a good dispersion of lignin powder and the at least one thermoset resin in powder form is achieved. A good dispersion in turn facilitates further processing and provides the obtained lignin-thermoset resin material with uniform properties.

Optionally, at least one additive may be added during mixing. Any suitable additives, such as binders or lubricants, may be added to facilitate the subsequent compaction process and to improve the density and mechanical properties of the obtained agglomerated lignin-thermoset resin material. In addition, additives having an influence on the properties of the final material may be added, such as functionality-enhancing additives. The total amount of additive(s) is preferably less than 5 wt %, such as less than 2 wt %, as based on the total dry weight of the mixture of lignin powder, thermoset resin and additive(s).

The compaction of the lignin-thermoset resin mixture in step ii) is preferably carried out by roll compaction. The roll compaction of the lignin-thermoset resin mixture can be achieved by a roller compactor to agglomerate the material. In the compaction step, an intermediate product is generated. Here, the fine powder of lignin and thermoset resin is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction are known in the art.

After compaction, crushing is preferably carried out. In the crushing step, the intermediate product from the compaction step is subjected to crushing or grinding, such as by means of a rotary granulator, cage mill, beater mill, hammer mill or crusher mill and/or combinations thereof. During this step, a further intermediate product is generated.

After crushing, the crushed material is preferably subjected to a sieving step, to remove fine material. In addition, large material, such as agglomerates having a diameter larger than 5.0 mm, may be removed and/or recirculated back to the crushing step. In the sieving step, the intermediate product from the crushing step is screened by means of physical fractionation such as sieving, also referred to as screening, to obtain a product which is an agglomerated lignin-thermoset resin material with a defined particle size distribution set by the porosity of the sieves or screens in this step. The sieve or screen is selected such that most particles having a diameter below 100 (or 500) μm pass through the screen and are rejected and preferably returned to the compaction step, whereas most particles having a diameter above 100 (or 500) μm are retained and subjected to the subsequent heating step of the process according to the present invention. The sieving may be carried out in more than one step, i.e. the sieving can be carried out such that the crushed material from the crushing step passes sequentially through more than one screen or sieve.

In one embodiment of the roll compaction, the rolls configuration is such that the first roll has an annual rim in such configuration so that the powder in the nip region is sealed in the axial direction along the roller surface.

In one embodiment, the roll configuration is such that the nip region is sealed in the axial direction along the roller surface with a static plate. By ensuring that the nip region is sealed, loss of powder at the axial ends of the rollers is minimized as compared to entirely cylindrical nip rollers.

Due to the compaction of the lignin powder and the thermoset resin powder during preparation of the agglomerated lignin-thermoset resin material, the bulk density of the materials will increase as pressure is applied to the powders. This means that the agglomerated lignin-thermoset resin material will have a higher bulk density than the lignin powder and thermoset resin powder. More compact lignin particles may be beneficial during subsequent processing to carbon enriched materials, as compact lignin particles have been found to retain its shape with no melting or swelling. The presence of a thermoset resin in the agglomerates further improves the processability of the lignin. Thus, the combination of the presence of a thermoset resin together with lignin in the agglomerates and the agglomeration process itself will result in a lignin material that can be heat treated with retained shape and no melting or swelling.

The agglomerated lignin-thermoset resin material particles will also have a relatively higher hardness after compaction. Hard particles are advantageous during subsequent processing as they can resist physical impact during processing. Further, when using hard, compacted particles processing problems that might arise due to the presence of lignin dust on the surface of the particles are avoided. This is of particular importance in a large-scale process since dust can form explosive mixtures with air and also cause blockings inside processing equipment.

In preferred embodiments, the lignin provided in step a) of the method according to the present invention is provided in a dry state, such as in the form of agglomerated lignin or in the form of a lignin powder. In such embodiments, the lignin preferably remains in a dry state also when contacted with the thermoset resin in step c). Preferably, lignin is not dissolved during any of the steps of the inventive method.

According to a second aspect, the present invention relates to an agglomerated lignin-thermoset resin material having a particle size distribution such that at least 80 wt % of the agglomerates have a diameter within the range of from 0.2 mm to 5.0 mm. The agglomerated lignin-thermoset resin material comprises lignin and at least one thermoset resin. The agglomerated lignin-thermoset resin material may optionally comprise at least one additive. The agglomerated lignin-thermoset resin material according to the second aspect can be obtained by the method according to the first aspect.

Preferably, the lignin in the agglomerated lignin-thermoset resin material is kraft lignin, i.e. lignin obtained from through the kraft process. Preferably, the kraft lignin is obtained from softwood or hardwood.

The type of thermoset resin in the agglomerated lignin-thermoset resin material is not particularly limited, and any suitable thermoset resin can be used. In some embodiments, the thermoset resin in the agglomerated lignin-thermoset resin material is selected from the group of furan resins, such as polyfurfuryl alcohol, epoxy-based resins, phenolic resins, such as bakelite, vinyl esters, melamine resins, and polyimides. Preferably, the thermoset resin is a furan resin, such as polyfurfuryl alcohol. In some embodiments, more than one thermoset resin is selected.

In some embodiments, the total amount of thermoset resin in the agglomerated lignin-thermoset resin material is in the range of from 1 wt % to 70 wt %, such as from 1 wt % to 50 wt %, or from 1 wt % to 20 wt %, or from 1 wt % to 10 wt %, based on the total dry weight of the agglomerated lignin-thermoset resin material.

The agglomerated lignin-thermoset resin material according to the second aspect may be further defined as set out above with reference to the first aspect.

According to a third aspect, the present invention relates to a method for producing a carbon material. The method according to the third aspect involves providing an agglomerated lignin-thermoset resin material obtainable by the method according to the first aspect, or an agglomerated lignin-thermoset resin material according to the second aspect. The agglomerated lignin-thermoset resin material and method for producing it are further defined as set out above with reference to the first aspect.

The method according to the third aspect may thus comprise performing the method according to the first aspect.

The method according to the third aspect also involves subjecting the agglomerated lignin-thermoset resin material to heat treatment at one or more temperatures in the range of from 300° C. to 3000° C. The heat treatment is carried out for a total time in the range of from 30 minutes to 10 hours, i.e. the residence time of the lignin-thermoset resin material inside the equipment used for the heat treatment is in the range of from 30 minutes to 10 hours, so as to obtain a carbon material. The obtained carbon retains the shape of the agglomerated lignin-thermoset resin starting material, i.e. the agglomerated lignin-thermoset resin material does not change its dimension or sell or melt during the heat treatment. The resulting carbon material is suitable for use in for example energy storage applications, such as active material in a negative electrode of a secondary battery.

The term “heat treatment” as used herein, refers to a process of heating the agglomerated lignin-thermoset resin material at one or more temperatures and for a sufficient time so that the carbon content of the agglomerated lignin-thermoset resin material is increased, and so that the agglomerated lignin-thermoset resin material is converted to a carbon material. Depending on the temperature during the heat treatment, different types of carbon materials, such as charcoal or hard carbon, can be obtained from the agglomerated lignin-thermoset resin material.

The terms “carbon material” and “carbon enriched material” are both used herein to denote a material consisting largely, such as at least 80 wt %, or at least 90 wt %, or at least 95 wt %, of carbon, and obtained by carbonization of an organic compound.

The heat treatment may be carried out at the same temperature throughout the entire heat treatment or may be carried out at varying temperature, such as a stepwise increase of the temperature or using a temperature gradient. The heat treatment may comprise a temperature ramp from a starting temperature to a target temperature. The heating rate may be 1-100 °C./min. For example, the heat treatment may involve several intermediate temperatures, with temperature ramps in between them, before reaching the target temperature needed for carbonization of the lignin-thermoset resin material. The heat treatment may be carried out as a batch process or a continuous process. Any suitable reactor can be used, such as rotary kiln, moving bed furnace, pusher furnace or rotary hearth furnace. The heat treatment is preferably carried out under inert atmosphere, preferably nitrogen atmosphere.

In some embodiments, heat treatment is carried out directly following curing of the provided agglomerated lignin-thermoset resin material according to the method according to the first aspect of the invention. For example, curing of the agglomerated lignin-thermoset resin material may first be carried out at one or more temperatures in the range of from 20° C. to 250° C., such as from 20° C. to 200° C., or 20° C. to 150° C., or 50° C. to 150° C., and the temperature may then be increased to temperatures employed during the heat treatment. The increase in temperature may be stepwise or may comprise a temperature ramp. The curing may thus in some embodiments be carried out in the same reactor as the subsequent heat treatment.

Preferably, the heat treatment comprises a preliminary heating step, preferably followed by a final heating step. The preliminary heating step is preferably carried out at one or more temperatures in the range of from 300° C. to 800° C., such as from 500° C. to 700° C. The preliminary heating step is preferably carried out under inert atmosphere, preferably nitrogen atmosphere. The duration of the preliminary heating step is at least 30 minutes and preferably less than 10 hours. The surface area of the carbon material obtained after the preliminary heating step is typically in the range of from 300 to 700 m²/g, measured as BET using nitrogen gas.

The final heating step is preferably carried out at one or more temperatures in the range of from 800° C. to 3000° C. The final heating step is preferably carried out under inert atmosphere, preferably nitrogen atmosphere. The duration of the final heating step is at least 30 minutes and preferably less than 10 hours. After the final heating step carried out at 1000° C. or higher, the surface area of the carbon material obtained is typically 50 m²/g or less.

The preliminary and final heating steps may be carried out as discrete steps or as one single step in direct sequence. The preliminary and final heating steps may involve heating at one or more temperatures, as discussed above for the heat treatment. For example, the preliminary heating starts at about 300° C. and the temperature is subsequently increased to about 500° C. The final heating step is preferably carried out between 900° C. and 1300° C., such as at about 1000° C.

The preliminary and final heating steps may be carried out as batch processes or as continuous processes. Any suitable reactors can be used. The preliminary heating step and the final heating step can be carried out in the same reactor or in separate reactors.

In some embodiments, the method according to the third aspect further comprises a step of milling the agglomerated lignin-thermoset resin material, or the obtained carbon material. Milling may be carried out prior to heat treatment, during heat treatment or after heat treatment, and may be carried out on the (cured) agglomerated lignin-thermoset resin material, or on the obtained carbon material.

Alternatively, if the heat treatment comprises a preliminary heating step and a final heating step, milling may be carried out after the preliminary heating step or after the final heating step. Several milling steps may also be carried out. Milling is performed so that the average particle size is reduced. Milling may be performed by methods such as impact milling, hammer milling, ball milling and jet milling. Optionally, fine/coarse particle selection by classification and/or sieving may be performed subsequent to the milling.

After heat treatment, and optional milling, the obtained carbon material may undergo further processing, such as e.g. carbon-coating by chemical vapor deposition (CVD), pitch coating, thermal and/or chemical purification, further heat treatment(s), particle size adjustment, and blending with other electrode materials to e.g. further improve its electrochemical performance.

The carbon material obtainable by the method according to the third aspect is preferably used as an active material in a negative electrode of a non-aqueous secondary battery, such as a lithium-ion battery. When used for producing such a negative electrode, any suitable method to form such a negative electrode may be utilized. In the formation of the negative electrode, the carbon enriched material may be processed together with further components. Such further components may include, for example, one or more binders to form the carbon enriched material into an electrode, conductive materials, such as carbon black, carbon nanotubes or metal powders, and/or further Li storage materials, such as graphite or lithium. For example, the binders may be selected from, but are not limited to, poly(vinylidene fluoride), poly(tetrafluoroethylene), carboxymethylcellulose, natural butadiene rubber, synthetic butadiene rubber, polyacrylate, poly(acrylic acid), alginate, etc., or from combinations thereof. Optionally, a solvent such as e.g. 1-methyl-2-pyrrolidone, 1-ethyl-2-pyrrolidone, water, or acetone is utilized during the processing.

According to a fourth aspect, the present invention relates to a carbon material obtainable by the method according to the third aspect. The carbon material obtainable by the method according to the third aspect is suitable for use in for example energy storage applications, such as active material in a negative electrode of a secondary battery. The carbon material according to the fourth aspect may be further defined as set out above with reference to the third aspect.

According to a fifth aspect, the present invention relates to a negative electrode of secondary battery comprising the carbon material obtainable by the method according to the third aspect as active material. The carbon material of the negative electrode according to the fifth aspect may be further defined as set out above with reference to the third aspect.

According to a sixth aspect, the present invention relates to use of the carbon material obtainable by the method according to the third aspect as active material in a negative electrode of a secondary battery. The carbon material of the sixth aspect may be further defined as set out above with reference to the third aspect.

### EXAMPLES

### Example 1

Lignin powder from the LignoBoost process was agglomerated by means of roller compaction. The resulting agglomerated lignin had an average size in the range of from 0.2 to 2.0 mm. The agglomerated lignin was coated with liquid thermoset resin, so that the total amount of thermoset resin in the resulting agglomerated lignin-thermoset resin material was 5 wt %. The material was dried at room temperature for 12 hours. The coated and dried agglomerated lignin was cured thermally using a stepwise sequence, involving heating at 50° C. for 1 hour, at 70° C. for 1 hour, at 90° C. for 1 hour and at 150°°C. for 1 hour. The material gradually darkened during the processing. After curing, the agglomerated lignin-thermoset resin material was carbonized at 500° C. to 1400° C. under inert atmosphere. The shape was retained during carbonization, and no melting was observed.

### Example 2—Comparative

Lignin powder from the LignoBoost process was agglomerated by means of roller compaction. The resulting agglomerated lignin had an average size in the range of from 0.2 to 2.0 mm. The agglomerated lignin was carbonized at 500° C. to 1400° C. under inert atmosphere. The agglomerated lignin melts during carbonization and excessive foaming occurs.

In view of the above detailed description of the present invention, other modifications and variations will become apparent to those skilled in the art. However, it should be apparent that such other modifications and variations may be effected without departing from the spirit and scope of the invention.

1. A method for producing an agglomerated lignin-thermoset resin material, wherein the method comprises the steps of:
providing lignin;
providing at least one thermoset resin;
forming an agglomerated lignin-thermoset resin material having a particle size distribution such that at least 80 wt % of agglomerates of the agglomerated lignin-thermoset resin material have a diameter within a range of from 0.2 mm to 5.0 mm, wherein the forming involves contacting the lignin with the at least one thermoset resin; and
curing the agglomerated lignin-thermoset resin material.

2. The method according to claim 1, wherein the lignin comprises an agglomerated lignin having a particle size distribution such that at least 80 wt % of agglomerates of the agglomerated lignin have a diameter within a range of from 0.2 mm to 5.0 mm.

3. The method according to claim 2, wherein the agglomerated lignin is produced by:
a) providing lignin as a powder, wherein a particle size distribution of the lignin as the powder is such that at least 80 wt % of the particles have a diameter less than 0.2 mm and a moisture content of less than 45 wt %;
b) compacting the powder of step a); and,
c) crushing a compacted lignin obtained in step b) so as to obtain the agglomerated lignin; and
d) optionally, sieving the agglomerated lignin obtained in step c) to remove particles having a particle diameter below 100 μm.

4. The method according to claim 3, wherein the powder is mixed with at least one additive prior to compacting.

5. The method according to claim 2, wherein the at least one thermoset resin comprises a liquid, and
wherein the step of forming the agglomerated lignin-thermoset resin material involves coating the agglomerated lignin with the at least one thermoset resin so as to obtain the agglomerated lignin-thermoset resin material.

6. (canceled)

7. (canceled)

8. The method according to claim 1, wherein the lignin comprises a powder,
wherein a particle size distribution of the powder is such that at least 80 wt % of particles have a diameter less than 0.2 mm and a moisture content of less than 45 wt %.

9. The method according to claim 8, wherein the at least one thermoset resin comprises a powder.

10. The method according to claim 9, wherein the step of forming the agglomerated lignin thermoset resin material comprises:
i) mixing the lignin powder, and the at least one thermoset resin powder, and, optionally, at least one additive, so as to obtain a lignin-thermoset resin mixture;
ii) compacting the lignin-thermoset resin mixture obtained in step i) so as to obtain a lignin-thermoset resin material; and,
iii) crushing the lignin-thermoset resin material obtained in step ii) so as to obtain the agglomerated lignin-thermoset resin material; and,
iv) optionally, sieving the agglomerated lignin-thermoset resin material obtained in step iii) so as to remove particles having a particle diameter below 100 μm.

11. (canceled)

12. (canceled)

13. The method according to claim 1, wherein a total amount of thermoset resin in the agglomerated lignin-thermoset resin material is in a range of from 1 to 70 wt %, based on a total dry weight of the agglomerated lignin-thermoset resin material.

14. The method according to claim 1, wherein the curing is carried out at one or more temperatures in a range of from 20° C. to 250° C. for a total time of at least 30 minutes.

15. The method according to claim 1, wherein an acidic catalyst is added to the at least one thermoset resin, and
wherein the curing of the agglomerated lignin-thermoset resin material is catalysed by the acidic catalyst.

16. An agglomerated lignin-thermoset resin material having a particle size distribution such that at least 80 wt % of agglomerates of the agglomerated lignin-thermoset resin material have a diameter within a range of from 0.2 mm to 5.0 mm.

17. The agglomerated lignin-thermoset resin material according to claim 16, wherein lignin in the agglomerated lignin-thermoset resin material comprises kraft lignin.

18. The agglomerated lignin-thermoset resin material according to claim 16, wherein a thermoset resin in the agglomerated lignin-thermoset resin material is selected from a group consisting of: furan resins, epoxy based resins, phenolic resins, vinyl esters, melamine resins, and polyimides.

19. The agglomerated lignin-thermoset resin material according to claim 16, wherein a total amount of a thermoset resin in the agglomerated lignin-thermoset resin material is in a range of from 1 to 70 wt %, based on a total dry weight of the agglomerated lignin-thermoset resin material.

20. A method for producing a carbon material, the method comprising the steps of:
providing the agglomerated lignin-thermoset resin material obtained by the method according to claim 1; and,
subjecting the agglomerated lignin-thermoset resin material to a heat treatment at one or more temperatures in a range of from 300° C. to 3000° C., wherein the heat treatment is carried out for a total time in a range of from 30 minutes to 10 hours, so as to obtain a carbon material.

21. The method according to claim 20, wherein the heat treatment comprises a preliminary heating step, followed by a final heating step.

22. The method according to claim 21, wherein the preliminary heating step is carried out at one or more temperatures in a range of from 400° C. to 800° C. for at least 30 minutes.

23. (canceled)

24. The method according to claim 21, wherein the final heating step is carried out at one or more temperatures in a range of from 800° C. to 3000° C. for at least 30 minutes.

25. (canceled)

26. The method according to claim 20, further comprising:
milling the agglomerated lignin-thermoset resin material or the carbon material.

27. (canceled)

28. (canceled)

29. (canceled)
